(19) United States
(12) Patent Application Publication
(10) Pub. No.: US 2004/0179135 A1
(43) Pub. Date: Sep. 16, 2004

(54) Illuminated user interface

(76) Inventors: Amy E. Battles, Windsor, CO (US); James C. Dow, Fort Collins, CO (US)

Correspondence Address: HEWLETT-PACKARD COMPANY, Intellectual Property Administration, P. O. Box 272400, Fort Collins, CO, 80527-2400, US

(21) Appl. No.: 10/389,344

(22) Filed: Mar. 14, 2003

(51) Int. Cl. H04N 5/225

(52) U.S. Cl. 348/373

(57) ABSTRACT

An illuminated interface system provides a user with information regarding the operation of an electronic device in communication with a docking station therefor. A plurality of illumination sources each emit light of certain states depending on the status of the electronic device. A controller is provided for controlling activation of the illumination sources. The illumination sources may be configured to have a first illumination state for indicating when the electronic device is electrically connected to, and operative to communicate with, the docking station and another device; a second illumination state for additionally indicating when a data transfer signal is being communicated between the first electronic device and the docking station or another device, and a third illumination state for indicating when the electronic device is not operative to communicate with another device. Such light sources may also be associated with the input means to further control activity of the devices, thereby initiating certain illumination states.

### BACKGROUND

Modern electronic devices are typically provided with light sources or illumination areas to inform a user of a certain condition of the device (e.g., illuminate if the device is turned “on”, deactivate if the device is turned “off”). These illumination areas may also be integrated into various input means on an electronic device, such as pushs-buttons or keys, that allow a user to select a function for the device to perform. For example, a docking station may have a general light source to inform the user that that power is being supplied to the docking station and an illuminated input means that allows a user to turn “on” the docking station such that it may interface with a peripheral electronic device, such as a laptop computer or digital camera. Additionally, many electronic devices have a display area presenting the user with information about one or more functions performed by the device. Such information could be in the form of a textual or graphical display, or other forms of information display. Depending on the device functionality, it may have any number of light sources, keys and/or display areas from which a user can input commands or obtain information.

Unfortunately, not all electronic devices have display areas configured to provide the user with sufficient information about the operation or current status of the device or the availability of the device to perform a function. Even if such displays are present, they may be too small for the user to easily navigate. Further, such a display adds complexity and cost to passive devices, such as docking stations. At the same time, the functionality of typical light sources is such that a user is provided limited feedback about the operations presently undertaken by the device. The guide light sources used in electronic devices are typically static—the light source illuminates for only one function of electronic device—and provide limited information to assist the device operator. Further, theses guide light sources are only operable for the particular device upon which they are mounted and do not facilitate use of or provide the status of the interfaced devices.

### SUMMARY

An illuminated interface system is described that provides information about the operation of a first electronic device in conjunction with a second device. This system comprises an light source having various states of illumination and a controller that controls activation of the illumination area. The light source is operably configured to have a first illumination mode for indicating when the electronic device is electrically connected to and in communication with, the second device; a second illumination mode distinct from the first illumination mode for indicating when a data transfer signal is being communicated between the first electronic device and the second device, and a third illumination mode distinct from the first and second illumination mode for indicating when the electronic device is inoperative to communicate with the second device.

In an alternative embodiment, an illuminated interface system is described wherein light sources are associated with the input means to further control activity of the electronic devices, thereby initiating certain illumination states.

### BRIEF DESCRIPTION OF THE FIGURES

FIG. 1 is a perspective view of a digital camera and docking station having the illuminated interface system of the present invention.

FIG. 2 is a perspective view of an alternative embodiment of the illuminated interface system of the present invention.

FIG. 3 is a schematic block diagram of the digital camera and docking station of FIGS. 1 and 2 shown interfaced with a secondary electronic device.

FIGS. 4A and 4B are block diagrams showing a sequence of light source activation for the docking station of FIG. 1.

FIGS. 5A and 5B are block diagrams showing a sequence of light source activation for the docking station of FIG. 2.

### DETAILED DESCRIPTION OF THE EMBODIMENTS

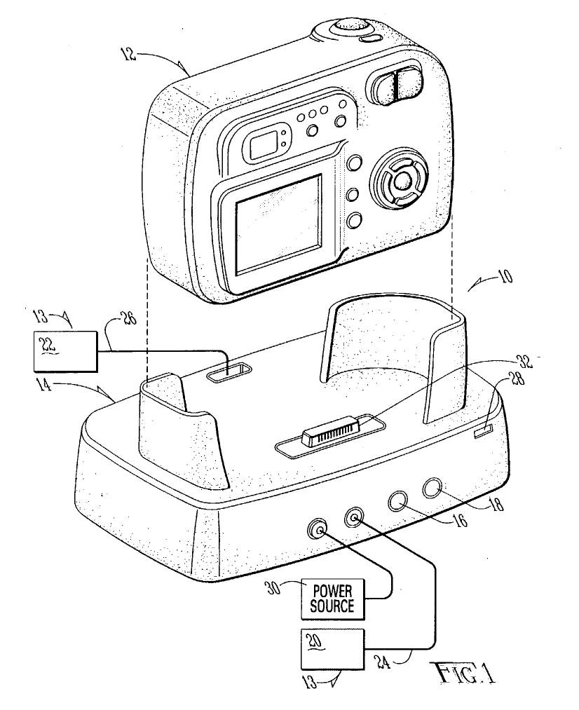

FIG. 1 shows an illuminated interface system 10 in which an electronic device, such as a digital camera 12 is used in conjunction with an interface module, such as a docking station 14. The docking station 14 is provided with a series of light sources or illuminators 16, 18 each of which correspond to a particular secondary (i.e., peripheral) electronic device 13, such as a monitor 20 or printer-equipped personal computer 22, that communicates with the interface module 14 through separate lines 24, 26. The light sources may be any light emitting device, such as miniature light bulbs, light-emitting diodes (LEDs), or low-power semiconductor lasers, e.g. surface-emitting lasers.

Two separate light sources may be provided as will be described in greater detail below, with each of these light sources emitting different color light. As an illustration, LEDs having dimensions on the order of 4 mm or less would make it possible to position two such LEDs behind a key which is approximately 8 mm wide. The different color LEDs could be selectively illuminated to signal different operating modes of the docking station 14. In a first operating mode, the light sources 16, 18 have a first illumination state, for example a solid green light in light source 16, to indicate that a device connected to line 24 (e.g., television 20) is electrically interfaced through docking station 14 with camera 12. A second operating mode initiates a second illumination state of the docking station for light sources 16, 18. For example, a blinking green light in light source 16 indicates that data transfer is taking place between the camera 12 and the peripheral electronic device (e.g., television 20) through docking station 14. The docking station is configured to enter a third operating mode in which the light sources 16, 18 have a third illumination state, such as a solid red light or no illumination, to indicate that no device is currently electrically interfaced with the camera 12 through lines 24 or 26. The third operating mode alternatively indicates that the activity associated with the second operating mode has been completed.

An additional docking light source 28 is preferably provided on the docking station 14 for indicating the status of a power supply, of the camera 12. Docking light source 28 alternatively may be located on the camera 12. The docking station 14 is connected to a power source 30 for providing general operating power to the docking station 14 and for recharging the battery of the camera 12. As with light sources 16, 18, docking light source 28 preferably has a plurality of different illumination states associated with various charging conditions for the camera 12. When the camera 12 is electrically connected to the docking station 14 by connector 32, a less than fully charged battery actuates a first illumination state on the light source 28, for example, a blinking yellow light. Once the battery has fully charged, the docking station 14 initiates a second illumination state on the light source 28, such as a solid yellow light. Upon the user removing the camera 12 from electrical connection with the docking station 14, the light source 28 ceases emitting light or emits light of another color (e.g., red), thus providing a third illumination state. The docking station also activates the third illumination state at such time when electrical power is not supplied to the docking station 14 by power source 30. Connector 32 allows for electrical power to be transferred from the docking station 14 to the camera 12 and also allows for data signals to be exchanged between the camera 12 and the docking station 14.

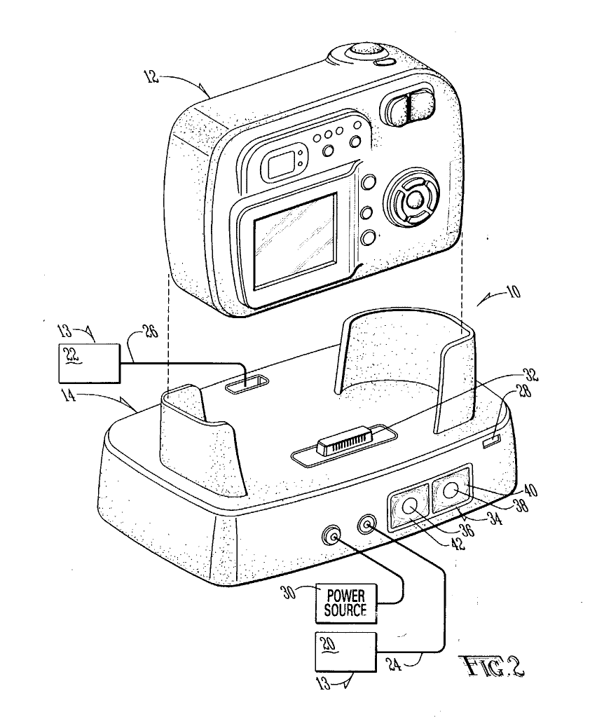

In FIG. 2, an alternative embodiment of the docking station 14 is shown having input means in the form of input keys 34 with light sources or illuminators 36, 38 disposed thereon. These keys 34 initiate certain functions on the docking station 14, such as a file download from the digital camera 12. By illuminating only those keys that provide valid responses for any given operation, the operator is guided through the proper operation of the camera without referring to the written manual or user's guide. Moreover, by identifying the proper keys to accomplish a particular menu command sequence, the user may more quickly complete the menu selection and is less likely to initiate an undesired command by pressing a wrong key

In addition to having the illumination states described above for light sources 16, 18, key light sources 36, 38 also are configured to illuminate in various states to assist the user in inputting commands on the docking station 14. For example, a “file transfer” key 40 illuminates in a solid green color to inform the user that initiation of the key 40 will start the exportation of image files from the camera 12. Once the files are transferred to the docking station 14 memory, key 40 ceases illuminating and a “MONITOR” key 42 illuminates in a solid color; illumination of key 42 informs the user that activation of configuration key 42 will transfer the files to the monitor 20 connected to line 24 for display.

In another configuration, key 40 has a “PC/Print” functionality such that initiation thereof will export image files to the printer-equipped personal computer 22. Keys 40 and 42 each illuminate in a unique color, such that the user quickly differentiates between the keys 40, 42 without having to read text labels associated with the keys.

A means for controlling the illumination activation for the docking station light sources is provided. The controlling means is preferably a controller, such as a data processor (e.g., model SPLB21 8-bit CMOS microprocessor of Sunplus Technology Co.) contained within either the camera 12 or the docking station 14. The controlling means is preferably incorporated into a processor that controls the full operation of the camera 12 or the docking station 14. It will be understood that the controlling means may be embodied in a dedicated user interface processor.

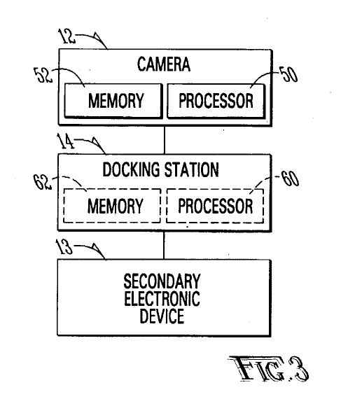

The illuminated interface system 10 is shown as a schematic block diagram in FIG. 3. Electronic device or camera 12 has a processor 50 for controlling general operation of the camera 12, memory 52 for storage of data to be transferred through docking station 14 to the peripheral device 13 (e.g., television 20) and embedded software instructions for directing the operation of the processor 50. In one configuration, the processor 50 comprises the means for controlling illumination of the various light sources of the docking station 14. In this configuration, functions associated with keys 34 on the docking station 14 are stored in the digital camera memory 52. In this configuration the docking station 14 is configured as a passive device, such that camera 12 controls illumination of various light sources disposed thereon. In this configuration, the docking station 14 does not have a memory such that data transfers between the camera 12 and the peripheral device 13 travel through station 14 without temporary storage in memory.

In an alternative configuration, docking station 14 includes a processor 60 for controlling general operation of the station 14, including illumination of the various light sources. The docking station 14 also has memory 62 for temporary storage of data transferred between the camera 12 and the peripheral device 13 and embedded software instructions for directing the operation of the processor 60. Depending on the configuration of the peripheral device 13, such as if the device is a personal computer, data signals may be generated by the device 13 and transferred through the docking station 14 back to the camera 12.

For each of the light sources of the illuminated interface system 10, the illumination states varies in terms of illumination level (e.g., intensity, blinking or variable illumination, no illumination), duration of illumination, as well as by color (e.g., red, green, amber). For example, the docking light source 28 may emit light of only one color, such as amber, while each of light sources 16, 18 may emit light of varying colors depending on the current operating mode of the docking station 14. By illuminating in this fashion, the user is provided with information regarding the current activities of the devices 12, 13 interfaced with the docking station 14, and is aided in choosing the desired function with keys 34 on the station 14 of FIG. 2.

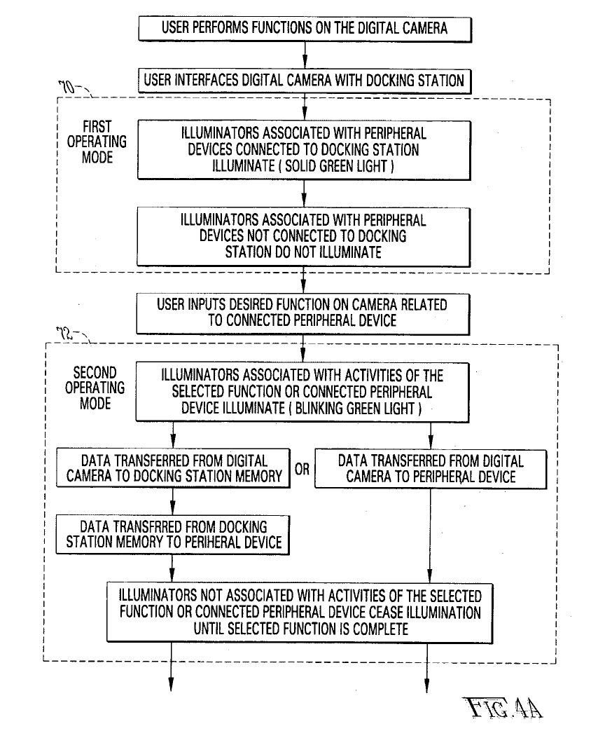

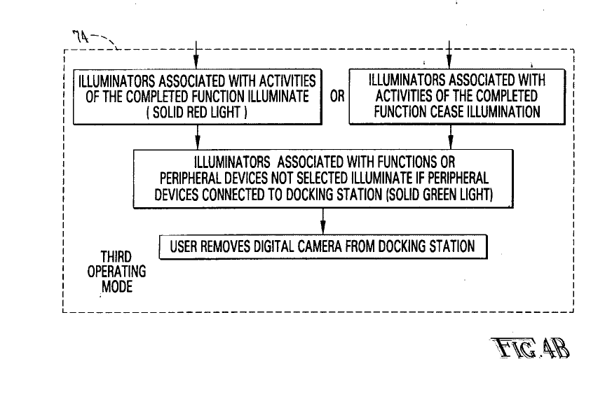

An exemplary flow diagram is shown, in FIGS. 4A and 4B, for the illuminated interface system 10 of FIG. 1. As seen in FIG. 4A, the user performs various functions on the camera 12, such as image capture and storage in camera memory. These selections may be made using various input buttons and menus on the camera 12. The camera 12 is placed in the docking station 14 for electrical connection therewith either before or during the time the user performs functions on the camera 12.

At this point, the light sources 16, 18 associated with the peripheral devices 13 connected to, and currently capable of interacting with, the docking station 14 through lines 24 or 26 enter a first operating mode 70 and illuminate. Conversely, light sources 16, 18 associated with the peripheral devices 13 not connected to, or capable of interacting with, the docking station 14 through lines 24 or 26 do not illuminate.

For example, light source 16 may emit solid green light to indicate that the monitor 20 is operative and connected through line 24, and light source 18 may emit solid green light to indicate that the printer-equipped personal computer 22 is operative and connected through line 26. Although preliminary signals may be sent between the digital camera 12 and docking station 14 at this point (e.g. status of battery, etc.), image file transfers take place substantially only during a second operating mode.

The second operating mode 72 is actuated upon the user inputting the desired functions to be performed on the camera 12. For example, if the user desires to store or print images taken by the camera 12 on the printer-equipped personal computer 22, the user selects on a camera interface that an image file or series of image files be exported. Light source 18 associated with the activities of the printer-equipped personal computer 22 activate a variable illumination level (i.e., blinking light) to indicate that data signals (e.g., image files) are being transferred from the camera 12 through the docking station 14 to the computer 22. The transferred image files are stored in memory of the docking station 14, if provided, for a certain amount of time before being transferred to the computer 22.

It should be understood that the second operating mode 72 may be entered immediately prior to any data signals being transferred, such that the associated light source 18 begins blinking before the docking station 14 receives any data from the camera 12 (e.g. upon the user initiating the file export function on the camera interface). This informs the user that the docking station 14 is preparing to facilitate a data transfer function. Also, in the second operating mode, the specific light source 16 associated with the peripheral device 13 not chosen, such as the monitor 20, ceases emitting light and enters a third operating mode until such time as the image file transfer is complete.

Upon completion of the export of the files from the camera 12 to the printer-equipped personal computer 22, the light source 18 associated with the computer 22 enters the third operating mode 74, as seen in FIG. 4B, and ceases illumination (or emits light of a different color, e.g., red). The light source 16 associated with the television 20 then returns to the first operating mode with solid illumination to indicate to the user that the television 20 is available to accept new data transfer from the camera 12, or the imported files from the computer 22. When the user has finished with all desired applications, the camera 12 may be removed from electrical and communicative connection to the docking station 14 and the light sources 16, 18 enter the third operating mode and cease emitting light.

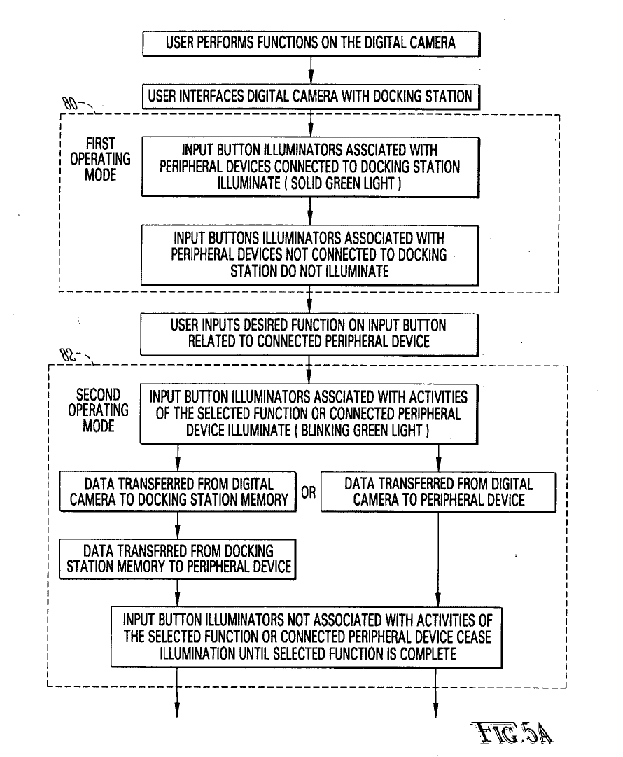

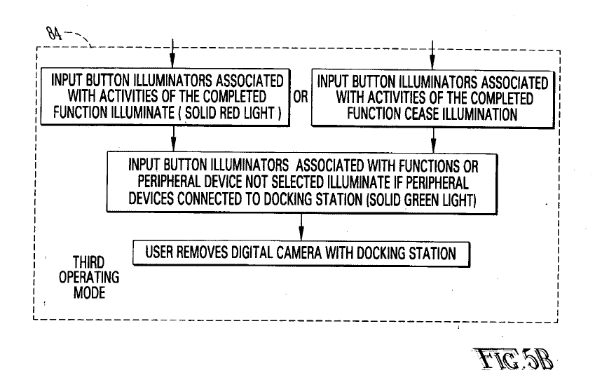

FIGS. 5A and 5B show an exemplary flow diagram for the illuminated interface system 10 of FIG. 2 having at least one key 34 and associated light sources. Similar to system 10 of FIG. 1, and as seen in FIG. 5A, the user first performs various functions on the camera 12, such as image capture and storage in camera memory. These selections are made using various input buttons and menus on the camera 12. The camera 12 is placed in the docking station 14 for electrical connection therewith either before or during the time the user performs functions on the camera 12.

At this point, the light sources 36, 38 associated with the peripheral devices 13, connected to and currently capable of interacting with, the docking station 14 through lines 24 or 26, enter a first operating mode 80 and illuminate. Also, the light sources 36, 38 may have varying illumination colors to inform the user of different functions that may be performed by each peripheral device 13. Although preliminary signals may be sent between the digital camera 12 and docking station 14 at this point (e.g. status of battery, etc.), image file transfers take place substantially only during a second operating mode.

The second operating mode 82 is entered by the user activation the desired key 34 (e.g., file transfer key 40) on docking station 14. A signal is sent to the camera 12 instructing the export of image files from the camera memory. The light source 38 associated with the file transfer key 40 provides a variable illumination level (i.e., blinking light) to indicate that data signals (e.g., image files) are being exported from the camera 12 to the docking station 14 memory, if present, or directly to the printer-equipped personal computer 22.

It should be understood that the second operating mode 82 may be entered immediately prior to any data signals being transferred, such that the associated light source 38 begins blinking before the docking station 14 receives any data from the camera 12 (e.g. upon the user depressing the desired key 34). This informs the user that the docking station 14 is preparing to facilitate a data transfer function. Also, in the second operating mode, the specific light source 36 associated with the peripheral device 13 not chosen, such as the television 20, ceases emitting light and enters a third operating mode until such time as the image file transfer is complete.

Upon completion of the export of the files from the camera 12 to the printer-equipped personal computer 22, the light source 38 associated with the computer 22 enters the third operating mode 84 and ceases illumination (or emits light of a different color, e.g., red), as seen in FIG. 5B. The light source 36 associated with the television 20 returns to the first state with solid illumination to indicate to the user that the television 20 is available to accept new data transfer from the camera 12 or the imported files from the computer 22, upon the user initiating the TV key 42. When the user has finished with all desired applications, the camera 12 may then be removed from electrical and communicative connection to the docking station 14 and the light sources 36, 38 of the keys 34 enter the third operating mode and cease emitting light.

From the foregoing information, it should now be obvious that the illuminated interface system 10 for providing a user with information regarding the operation of a first electronic device 12 in conjunction with another device 13 aids a user in operating such devices 12, 13 in a more efficient manner. While certain forms of the present invention have been illustrated and described herein, it is not to be limited to the specific forms or arrangement of parts described and shown.

What is claimed is:

1. A docking station interface for assisting a user in the operation thereof, the docking station interface comprising:
a module configured for interfacing with a first electronic device and a second electronic device, at least one of the first and second electronic devices being removably connected to the module;
a first light source for indicating that the first electronic device is electrically connected to, and operative to communicate with, the module;
a second light source for indicating that the second electronic device is electrically connected to, and operative to communicate with, the module; and
a controller for controlling illumination of the first and second light sources such that the first light source and second light source may enter into various illumination states, at least one of the first and second light sources configured to enter a first illumination state to indicate when the respective electronic device is electrically connected to, and operative to communicate with, the interfacing module, and a second illumination state having a varying illumination state from the first illumination state for additionally indicating substantially when a file transfer signal is being communicated between the respective electronic device and the module.

2. The docking station interface of claim 1, wherein the first electronic device and second electronic device are in communication with one another through the interface module.

3. The docking station interface of claim 1, further comprising an input means disposed on the interface module and associated with one of the first light source and the second light source to allow the user to initiate a command for the respective electronic device.

4. The docking station interface of claim 3, wherein the second illumination state is entered upon the user activating the input means.

5. The docking station interface of claim 1, further comprising at least one input key disposed on the interface module and associated with one of the first light source and the second light source to allow the user to initiate a command for the respective electronic device.

6. The docking station interface of claim 1, wherein the first electronic device is a digital camera.

7. The docking station interface of claim 1, wherein the second electronic device is one of a personal computer, a video monitor, and a printer.

8. The docking station interface of claim 1, wherein the light source is provided with a solid illumination level in the first illumination state.

9. The docking station interface of claim 1, wherein the light source is provided with a variable illumination level in the second illumination state.

10. A method for providing information to a user regarding the operation of an electronic device configured for removable connection to a docking station, the method comprising the steps of:
removably connecting the electronic device to the docking station; and
selectively illuminating at least one light source disposed on the docking station indicative of certain activity between the electronic device and the docking station, the step of selectively illuminating the at least one light source comprising:
illuminating the at least one light source in a first illumination state to indicate when the electronic device is electrically connected to, and operative to communicate with, the docking station;
illuminating the at least one light source in a second illumination state having a varying illumination state from the first illumination state for additionally indicating substantially when a data transfer signal is being communicated between the electronic device and the docking station; and
illuminating the at least one light source in a third illumination state having a varying illumination state from the first and second illumination states for indicating when the electronic device is not operative to communicate with the docking station.

11. The method of claim 10, wherein the docking station is configured to interface with a second electronic device, the method further comprising the steps of:
removably connecting the second electronic device to the docking station; and
selectively illuminating a second light source disposed on the docking station indicative of certain activity between the second electronic device and the docking station, the step of selectively illuminating the second light source comprising:
illuminating the second light source in a first illumination state to indicate when the electronic device is electrically connected to, and operative to communicate with, the docking station; and
illuminating the second light source in a second illumination state having a varying illumination state from the first illumination states for indicating when the electronic device is not operative to communicate with the docking station.

12. The method of claim 10, further comprising the steps of:
storing a set of functions, each function of the set of functions being associated with the activation of at least one particular input button disposed on the docking station, an light source being associated with each particular input button;
selectively illuminating, in response to a user initiating a particular input button, the associated light source indicative of certain activity between the electronic device and the docking station; and
performing the function chosen by the user.

13. The method of claim 12, wherein one of the set of functions includes transferring a file from the electronic device to the docking station.

14. The method of claim 10, wherein the electronic device is a digital camera.

15. The method of claim 10, wherein the first illumination state comprises providing the light source with a solid illumination level.

16. The method of claim 10, wherein the second illumination state comprises providing the light source with a variable illumination level.

17. The method of claim 10, wherein the third illumination state comprises providing the light source with no illumination level.

18. The method of claim 10, wherein the third illumination state comprises providing the light source with a color of illumination varying from the color of illumination provided in the first and second illumination states.

19. A method for instructing a user regarding the operability of an electronic device removably connected to a docking station, the method comprising the steps of:
selectively illuminating at least one light source disposed on the docking station indicative of certain activity between the electronic device and the docking station, the step of selectively illuminating the at least one light source comprising:
illuminating the at least one light source in a first illumination state to indicate when the electronic device is electrically connected to, and operative to communicate with, the docking station;
illuminating the at least one light source in a second illumination state having a varying illumination state from the first illumination state for additionally indicating substantially when a data transfer signal is being communicated between the electronic device and the docking station; and
illuminating the at least one light source in a third illumination state having a varying illumination state from the first and second illumination states for indicating when the electronic device is not operative to communicate with the docking station.

20. The method of claim 19, further comprising the steps of:
storing a set of functions, each function of the set of functions being associated with the activation of at least one particular input button disposed on the docking station, an light source being associated with each particular input button;
selectively illuminating, in response to a user initiating a particular input button, the associated light source indicative of certain activity between the electronic device and the docking station; and
performing the function chosen by the user.

21. The method of claim 20, wherein one of the set of functions includes transferring a file from the electronic device to the docking station.

22. The method of claim 19, wherein the electronic device is a digital camera.
